(19) United States
(12) Patent Application Publication
(10) Pub. No.: US 2024/0262145 A1
(43) Pub. Date: Aug. 8, 2024

(54) ROBOT AND ROBOT PROPULSION METHOD

(71) Applicant: NEC Corporation, Tokyo (JP)

(72) Inventor: Takeharu Kitagawa, Tokyo (JP)

(73) Assignee: NEC Corporation, Tokyo (JP)

(21) Appl. No.: 18/411,141

(22) Filed: Jan. 12, 2024

(30) Foreign Application Priority Data
Feb. 8, 2023 (JP) 2023-017952

(51) Int. Cl. B60F 5/02; B62D 57/032; B64U 10/70; B64U 30/12

(52) U.S. Cl. CPC B60F 5/02; B62D 57/032; B64U 10/70; B64U 30/12

(57) ABSTRACT

A walking robot includes a plurality of propulsion devices that are attached to the robot and apply thrust to the robot. At least one propulsion device of the plurality of propulsion devices is movably attached to a body unit by a movable device. The walking robot includes a control device. The control device performs posture control of changing a posture of the propulsion device attached to the body unit from a posture during walking by controlling the movable device during propulsion that is moving using the propulsion device. The control device performs direction control of a leg unit such that an extending direction of the leg unit during propulsion is opposite to a forward direction by controlling a hip joint actuator.

This application is based upon and claims the benefit of priority from Japanese Patent Application No. 2023-017952, filed on Feb. 8, 2023, the disclosure of which is incorporated herein in its entirety by reference.

### TECHNICAL FIELD

The present disclosure relates to a technique for a walking robot.

### BACKGROUND ART

Research and development of walking robots are in progress. For example, Citation Document 1 (Japanese Patent Application Laid-Open No. 2019-155505) discloses a technique for moving a walking robot in a suspended manner by a propulsion unit detachably connected to a top portion of the walking robot. Citation Document 2 (Japanese Patent Application Laid-Open No. 2006-297554) discloses a technique for moving a walking robot in a floated manner by a propeller that floats vertically upward. As described above, the walking robot that not only walks but also floats and moves using the propeller has been proposed.

### SUMMARY

A main object of the present disclosure is to provide a technique capable of increasing a moving distance per unit capacity of energy related to movement in a case where a robot is moved by a propulsion device as compared with a case where the robot is moved by the propulsion device in a walking posture.

According to an aspect of the present disclosure,
there is provided a walking robot equipped with an arm unit connected to a body unit via a shoulder joint actuator and a leg unit connected to the body unit via a hip joint actuator, including:
a plurality of propulsion devices which are attached to the robot and apply thrust to the robot;
a movable device which movably attaches at least one propulsion device of the plurality of propulsion devices to the body unit; and
a control device which controls respective operations of the shoulder joint actuator, the hip joint actuator, the plurality of propulsion devices, and the movable device,
wherein the control device performs posture control of changing a posture of the propulsion device attached to the body unit from a posture during walking by controlling the movable device during propulsion that is moving using the propulsion device and performs direction control of the leg unit such that an extending direction of the leg unit during propulsion is opposite to a forward direction by controlling the hip joint actuator.

According to another aspect of the present disclosure,
there is provided a robot propulsion method for a walking robot equipped with an arm unit connected to a body unit via a shoulder joint actuator and a leg unit connected to the body unit via a hip joint actuator, including a plurality of propulsion devices which are attached to the robot and apply thrust to the robot, a movable device which movably attaches at least one propulsion device of the plurality of propulsion devices to the body unit; and a control device which controls respective operations of the shoulder joint actuator, the hip joint actuator, the plurality of propulsion devices, and the movable device,
wherein the control device performs posture control of changing a posture of the propulsion device attached to the body unit from a posture during walking by controlling the movable device during propulsion that is moving using the propulsion device and
performs direction control of the leg unit such that an extending direction of the leg unit during propulsion is opposite to a forward direction by controlling the hip joint actuator.

### BRIEF DESCRIPTION OF THE DRAWINGS

Exemplary features and advantages of the present invention will become apparent from the following detailed description when taken with the accompanying drawings in which:

FIG. 1 is a perspective view schematically showing a robot according to a first example embodiment of the present disclosure;

FIG. 2 is a diagram illustrating a flying posture in the robot according to the first example embodiment;

FIG. 3 is a diagram illustrating an example of a travel route including the flying of the robot according to the first example embodiment;

FIG. 4 is a diagram illustrating an example of a control operation related to the flying of the robot according to the first example embodiment;

FIG. 5 is a flowchart showing an example of a control operation related to the flying of the robot according to the first example embodiment;

FIG. 6 is a diagram illustrating another example of a travel route including the flying of the robot;

FIG. 7 is a diagram showing another example of a control operation related to the flying of the robot;

FIG. 8 is a plan view of the robot according to a second example embodiment of the present disclosure as viewed from the upper side of the body unit;

FIG. 9 is a diagram illustrating an example of a travel route including the flying of the robot according to the second example embodiment;

FIG. 10 is a diagram illustrating an example of a control operation related to the flying of the robot according to the second example embodiment;

FIG. 11 is a diagram showing an example of a state in which an arm unit is inclined;

FIG. 12 is a diagram illustrating another example embodiment of the robot;

FIG. 13 is a diagram illustrating still another example embodiment of the robot;

FIG. 14 is a diagram illustrating still another example embodiment of the robot;

FIG. 15 is a diagram showing an example of a state in which blades are closed;

FIG. 16 is a diagram illustrating further still another example embodiment of the robot;

FIG. 17 is a diagram illustrating further still another example embodiment of the robot; and

FIG. 18 is a flowchart showing an example of a control operation related to the flying in the robot.

### EXAMPLE EMBODIMENT

Hereinafter, example embodiments according to the present disclosure will be described with reference to the drawings.

### First Example Embodiment

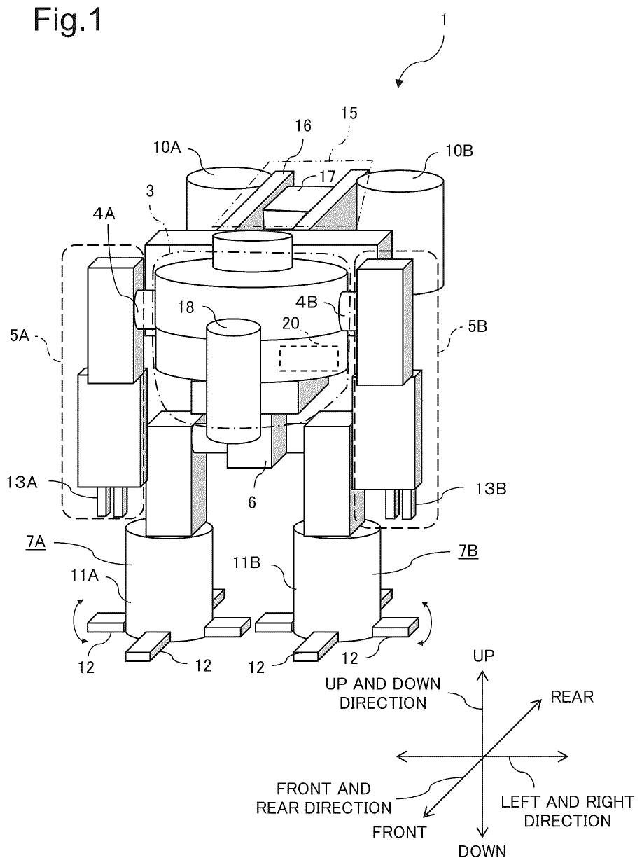

FIG. 1 is a perspective view schematically showing a robot according to a first example embodiment of the present disclosure. This robot is a robot (hereinafter, also referred to as a flying robot) 1 in which a flying function is added to a robot that can walk. The flying robot 1 has a configuration capable of increasing a moving distance (flying distance) per unit capacity of energy as compared with a case of flying in a posture (walking posture) during walking as shown in FIG. 1.

That is, the flying robot 1 includes a body unit 3. Two arm units 5A and 5B are disposed with the body unit 3 interposed therebetween, and the arm units 5A and 5B are connected to the body unit 3 via shoulder joint actuators 4A and 4B, respectively. The arm units 5A and 5B are rotatable about a portion connected to the body unit 3 by the shoulder joint actuators 4A and 4B. Here, the arm units 5A and 5B only need to function as arm units of the robot, the configuration including the presence or absence and the number of joint actuators mounted on the arm units 5A and 5B is not limited, and the description thereof will be omitted. However, in the example of FIG. 1, grip portions 13A and 13B are provided on the distal end sides of the arm units 5A and 5B, respectively. The grip portions 13A and 13B have a configuration capable of holding a preset object to be held. That is, the grip portions 13A and 13B have a configuration corresponding to an object to be held, and are not limited here. Accordingly, the description of the configuration of the grip portions 13A and 13B is omitted.

Here, in order to facilitate the description, three directions orthogonal to each other are set. One of the three directions is a direction in which the arm units 5A and 5B are arranged via the body unit 3, and is referred to as the left and right direction. Another one of the three directions is a direction in which the robot moves forward or backward during walking in which the robot walks, and is referred to as the front and rear direction. Still another one of the three directions is referred to as the up and down direction.

Two leg units 7A and 7B are further connected to the body unit 3 via a hip joint actuator 6. The leg units 7A and 7B are rotatable about a portion connected to the hip joint actuator 6 by the hip joint actuator 6, and can be moved forward or backward.

Propulsion devices 11A and 11B are incorporated in the leg units 7A and 7B, respectively. The propulsion devices 11A and 11B each include a rotary wing (not shown) and a drive mechanism of the rotary wing. The rotary wing is provided so as to be rotatable about a center axis along an extending direction (in the example of FIG. 1, the up and down direction) of the leg units 7A and 7B. The propulsion devices 11A and 11B can apply thrust in a direction along the rotation center axis of the rotary wing (upward in the example of FIG. 1) to the flying robot 1 by the rotation of the rotary wing by the drive mechanism.

The configuration of the leg units 7A and 7B other than the configuration related to the propulsion devices 11A and 11B only needs to include the configuration of the leg unit that enables the flying robot 1 to walk, and the configuration is not limited, and the description thereof will be omitted here. In the example of FIG. 1, a protruding piece 12 is provided on the distal end side of the leg units 7A and 7B in order to achieve stability of the flying robot 1 when the flying robot 1 stands or walks. A rotation mechanism is provided on the proximal end side of the protruding piece 12, and the protruding piece 12 is rotatable and displaceable about the proximal end side in a direction in which an angle formed with the extending directions of the leg units 7A and 7B is variable. Such a protruding piece 12 may be omitted depending on the use of the flying robot 1.

In the body unit 3, a plurality of propulsion devices 10A and 10B are further connected to a portion on the rear side (in other words, the rear surface side) of the flying robot 1 via a movable device 15. In this example, each of the propulsion devices 10A and 10B is a device having a configuration similar to that of the propulsion devices 11A and 11B, and can apply thrust in a direction along the rotation center axis of the rotary wing to the flying robot 1 by the rotation of the rotary wing using the drive mechanism. In the example of FIG. 1, the propulsion devices 10A and 10B are in a state in which upward thrust is generated.

The movable device 15 includes a support member 16 and a device rotary actuator 17. The support member 16 is a member that is fixed to the body unit 3 and supports each of the propulsion devices 10A and 10B. The propulsion devices 10A and 10B are connected to the support member 16 via the device rotary actuator 17. The device rotary actuator 17 changes the posture of the propulsion devices 10A and 10B by rotating the propulsion devices 10A and 10B as follows. The rotation directions of the propulsion devices 10A and 10B by the device rotary actuator 17 is a direction in which the direction along the rotation center axis of the rotary wings in the propulsion devices 10A and 10B is rotated from the up and down direction to the front and rear direction in FIG. 1 or in the opposite direction.

An air resistance reducing member 18 is further provided on the front side of the body unit 3. One end side (the upper end side in the example of FIG. 1) of the air resistance reducing member 18 is connected to the body unit 3 via an actuator (not shown). The other end side (the lower end side in the example of FIG. 1) of the air resistance reducing member 18 can be rotationally displaced by the actuator from a downward state as in FIG. 1 to a forward protruding state or vice versa.

The flying robot 1 is further equipped with various sensors (not shown) used for controlling operations such as a walking operation, a flying operation, and a gripping operation of the flying robot 1. Specific examples of the sensor mounted on the flying robot 1 include a gyro, an acceleration sensor, a distance measurement sensor, and an atmospheric pressure sensor. In addition, the flying robot 1 is equipped with a position detection device that detects a position using a GNSS (Global Navigation Satellite System (Global Positioning Satellite System)) such as a GPS (Global Positioning System). Furthermore, the flying robot 1 may be equipped with a photographing device (not shown) that photographs a situation around the flying robot 1. Furthermore, the flying robot 1 may be equipped with an antenna (not shown) for wireless communication with other devices.

The body unit 3 further incorporates a control device 20 and a battery (not shown). The battery is a power supply source (energy source) that supplies power to various actuators, the control device 20, various sensors, and the like mounted on the flying robot 1.

The control device 20 is a computer device, and causes the flying robot 1 to have a function based on a given computer program by executing the computer program. For example, the control device 20 performs arithmetic processing using sensor outputs output from various sensors, captured images by the imaging device, position information by the position detection device, and the like. Then, the control device 20 controls driving of various actuators and the like provided in the flying robot 1 to control operations such as a walking operation, a flying operation, and a gripping operation of the flying robot 1. Here, the control method of controlling operations other than the flying operation in the flying robot 1, that is, the walking operation, the gripping operation, and the like is not limited, and thus the description thereof will be omitted.

In the first example embodiment, as the control related to the flying operation of the flying robot 1, during flying, the control device 20 performs control to change the posture of the propulsion devices 10A and 10B and the directions of the leg units 7A and 7B to a state different from the state during walking. That is, in the first example embodiment, during walking, the posture of the propulsion devices 10A and 10B and the directions of the leg units 7A and 7B are in a standing posture as shown in FIG. 1. That is, in FIG. 1, the body unit 3 is in a state of standing along the up and down direction. Further, each of the propulsion devices 10A and 10B is in a posture in which the rotation center axis of the rotary wing is along the up and down direction. Furthermore, the leg units 7A and 7B each extends in the up and down direction.

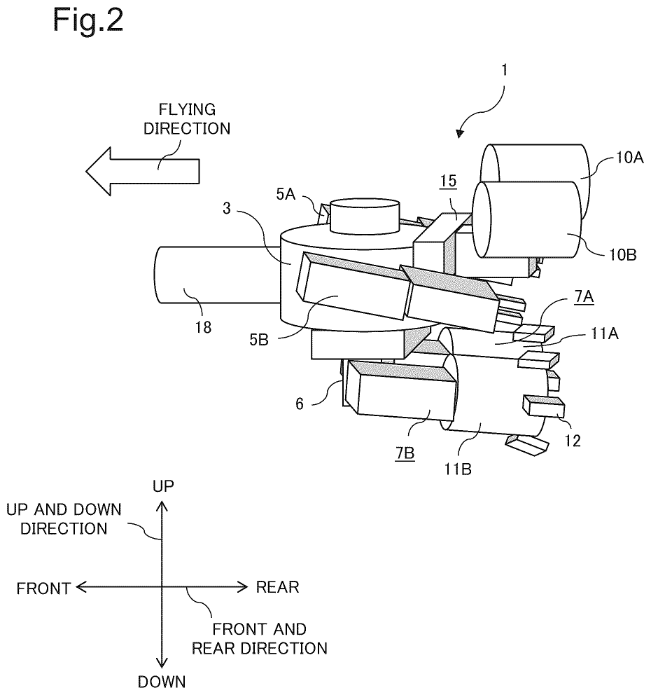

On the other hand, during flying, the control device 20 controls the hip joint actuator 6 and the device rotary actuator 17 of the movable device 15 to variably control the flying robot 1 to the flying posture (propulsion posture) as shown in FIG. 2. That is, the body unit 3 is in a standing state along the up and down direction similarly to walking even during flying (during propulsion moving using the propulsion device), but during flying, the propulsion devices 10A and 10B are variably controlled such that the posture of the propulsion devices changes from a direction along the rotation center axis of the rotary wing to the front and rear direction by the control of the device rotary actuator 17 of the movable device 15 using the control device 20. As a result, during flying, the direction of the thrust generated by the rotation of the rotary wings in the propulsion devices 10A and 10B is the front and rear direction.

In addition, during flying, the leg units 7A and 7B including the propulsion devices 11A and 11B are variably controlled such that the extending direction of the leg units is along the front and rear direction by the control of the hip joint actuator 6 using the control device 20. As a result, the direction of the thrust of the propulsion devices 11A and 11B during flying is also the front and rear direction similarly to the propulsion devices 10A and 10B. With the posture of the propulsion devices 10A, 10B, 11A, and 11B, the flying direction (forward direction) of the flying robot 1 is a direction along the front and rear direction as shown in FIG. 2. In other words, the posture of the propulsion devices 10A, 10B, 11A, and 11B is variably controlled in such a way that thrust in a direction along the target flying direction can be applied to the flying robot 1. In addition, during flying, the direction of the leg unit 7 is controlled such that the extending direction of the leg unit 7 is opposite to the flying direction, in such a way that the air resistance by the leg unit 7 is reduced.

Further, the control device 20 causes the air resistance reducing member 18 to face downward as shown in FIG. 1 when the flying robot 1 is in the standing posture and causes the air resistance reducing member 18 to protrude forward as shown in FIG. 2 during flying by the control of an actuator (not shown) connecting the air resistance reducing member 18 and the body unit 3.

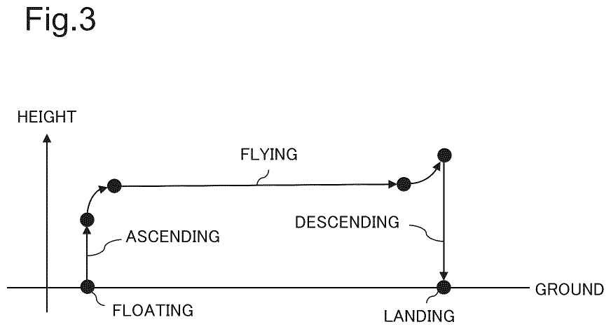

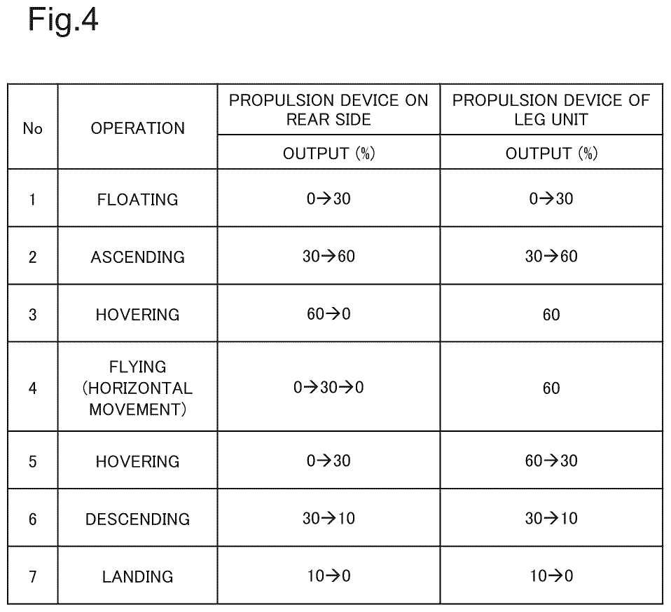

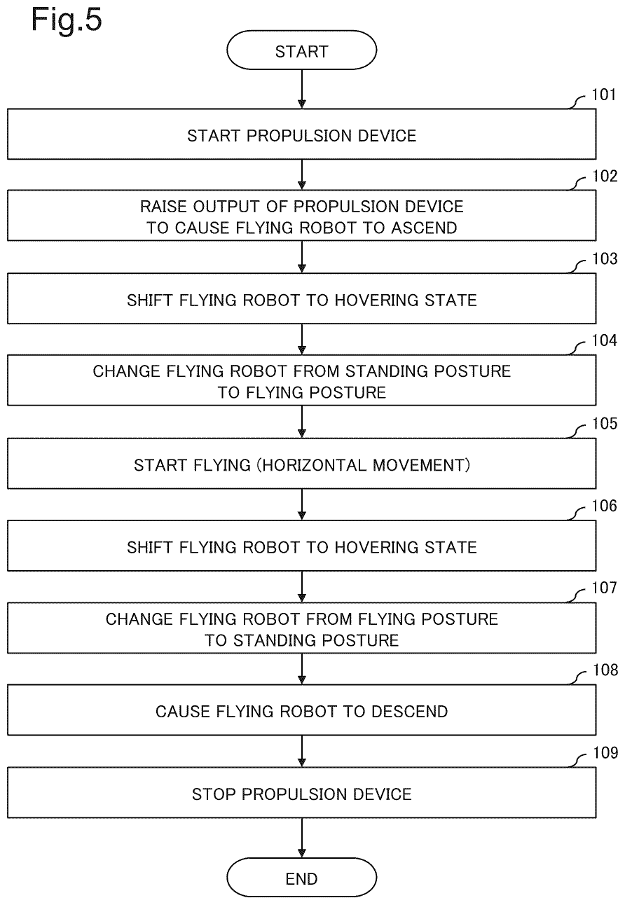

The flying robot 1 is configured as described above. Hereinafter, an example of an operation related to the flying of the control device 20 in the flying robot 1 will be described with reference to FIGS. 3 to 5. FIG. 3 is a diagram showing an example of a travel route including the flying of the flying robot 1. FIG. 4 is a diagram illustrating an example of outputs of the propulsion devices 10A, 10B, 11A, and 11B when the flying robot 1 moves as shown in FIG. 3. FIG. 5 is a flowchart showing an example of an operation related to the flying of the control device 20. Furthermore, the output of the propulsion device shown in FIG. 4 represents the magnitude of the output in a case where the rated output of the motor (for example, a brushless motor) that rotates the rotary wing is 100%.

For example, it is assumed that the flying robot 1 is in the standing posture on the ground as shown in FIG. 1. In this state, the control device 20 first starts both the propulsion devices 10A and 10B on the rear side and the propulsion devices 11A and 11B of the leg units 7A and 7B (step 101 in FIG. 5), and increases the outputs of the propulsion devices 10A, 10B, 11A, and 11B to about 30%. As a result, the flying robot 1 floats. Subsequently, the control device 20 raises the outputs of the propulsion devices 10A, 10B, 11A, and 11B to about 60%, thereby causing the flying robot 1 to ascend in the up and down direction as shown in FIG. 3 while keeping the standing posture (step 102).

When the flying robot 1 ascends to the target height, the control device 20 shifts the flying robot 1 to the hovering state (step 103). At this time, for example, the control device 20 lowers the outputs of the propulsion devices 10A and 10B on the rear side to 0%, and keeps a state in which the outputs of the propulsion devices 11A and 11B of the leg units 7A and 7B are 60%.

In addition, in the hovering state, the control device 20 controls the device rotary actuator 17 and the hip joint actuator 6 of the movable device 15 to change the posture of the propulsion devices 10A and 10B and the directions of the leg units 7A and 7B (propulsion devices 11A and 11B) to the flying posture as shown in FIG. 2. In other words, the control device 20 changes the posture of the flying robot 1 from the standing posture to the flying posture (step 104). In addition, the control device 20 changes the direction of the air resistance reducing member 18. Furthermore, in the example of FIG. 2, during flying, the control device 20 controls the shoulder joint actuators 4A and 4B to change the directions of the arm units 5A and 5B to a direction in which the air resistance by the arm units 5A and 5B decreases.

Thereafter, the control device 20 starts the flying (horizontal movement) of the flying robot 1 by raising the output of the propulsion devices 10A and 10B on the rear side to 30% (step 105), and lowers the output of the propulsion devices 10A and 10B on the rear side to 0% when the flying state is stabilized. On the other hand, the control device 20 keeps the state in which the outputs of the propulsion devices 11A and 11B of the leg units 7A and 7B are 60%.

When the flying robot 1 reaches the sky above the destination, the control device 20 shifts the flying robot 1 to the hovering state (step 106). At this time, for example, the control device 20 increases the outputs of the propulsion devices 10A and 10B on the rear side to 30%, and decreases the outputs of the propulsion devices 11A and 11B of the leg units 7A and 7B to 30%. In addition, the control device 20 controls the device rotary actuator 17 and the hip joint actuator 6 of the movable device 15 in the hovering state to change the posture of the propulsion devices 10A and 10B and the directions of the leg units 7A and 7B (propulsion devices 11A and 11B) while performing such output control of the propulsion device. In other words, the control device 20 changes the flying robot 1 from the flying posture to the standing posture (step 107). In addition, the control device 20 changes the posture of the air resistance reducing member 18 and the directions of the arm units 5A and 5B.

Thereafter, the control device 20 causes the flying robot 1 to descend by lowering the outputs of the propulsion devices 10A and 10B on the rear side and the propulsion devices 11A and 11B of the leg units 7A and 7B to about 10% (step 108). Then, when the flying robot 1 has landed, the control device 20 reduces the outputs of the propulsion devices 10A, 10B, 11A, and 11B to 0%. That is, the control device 20 stops the propulsion devices 10A, 10B, 11A, and 11B (step 109).

In this way, the control device 20 controls the flying of the flying robot 1 by controlling the propulsion devices 10A, 10B, 11A, and 11B, the movable device 15, the hip joint actuator 6, and the like. In order to stabilize the flying of the flying robot 1, the control device 20 may control the output of each of the propulsion devices 10A, 10B, 11A, and 11B using various sensors to perform posture control such as pitching, rolling, and yawing. However, since this control method is not limited, the description thereof is omitted here.

The flying robot 1 of the first example embodiment is configured as described above. While the posture of the body unit 3 of the flying robot 1 does not change during walking or flying, the posture of the propulsion devices 10A and 10B changes by the operation of the movable device 15 according to the control of the control device 20. As a result, each of the propulsion devices 10A and 10B applies thrust in the flying direction to the flying robot 1. For this reason, the posture control of the propulsion devices 10A, 10B, 11A, and 11B is not performed, and for example, the thrust of the flying robot 1 in the flying direction can be increased as compared with the case of a state like a drone having four rotary wings. As a result, the flying robot 1 can increase the moving distance (flying distance) by flying per unit capacity of the battery (energy source) as compared with the case of flying in the standing posture (walking posture). In other words, when the posture control of the propulsion device is performed as described above, the flying robot 1 can increase the moving distance per unit capacity of the energy related to the movement in the case of moving the robot by the propulsion device as compared with the case of moving the robot by the propulsion device in the walking posture. In particular, in the first example embodiment, not only the propulsion devices 10A and 10B but also the propulsion devices 11A and 11B incorporated in the leg units 7A and 7B change their postures such that the direction of the thrust applied to the flying robot 1 becomes the flying direction during flying. This contributes to the fact that the flying robot 1 can further increase the moving distance (flying distance) by flying per unit capacity of the battery (energy source).

### Modified Example of First Example Embodiment

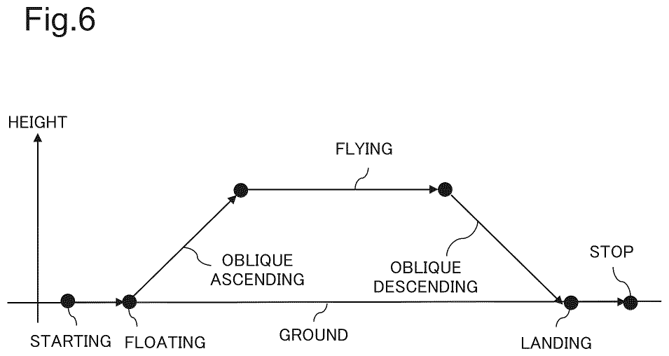

In the example of the control related to the flying using the control device 20 described above, the flying robot 1 ascends in the up and down direction from the ground as shown in FIG. 3, and descends in the up and down direction toward the ground. Alternatively, as shown in FIG. 6, the control device 20 may control the flying in such a way that the flying robot 1 obliquely ascends or descends. In addition, the flying robot 1 may be transformed on the ground instead of being transformed from the standing posture to the flying posture or vice versa by the control of the control device 20 in the air. That is, the control device 20 may perform the following control related to the flying.

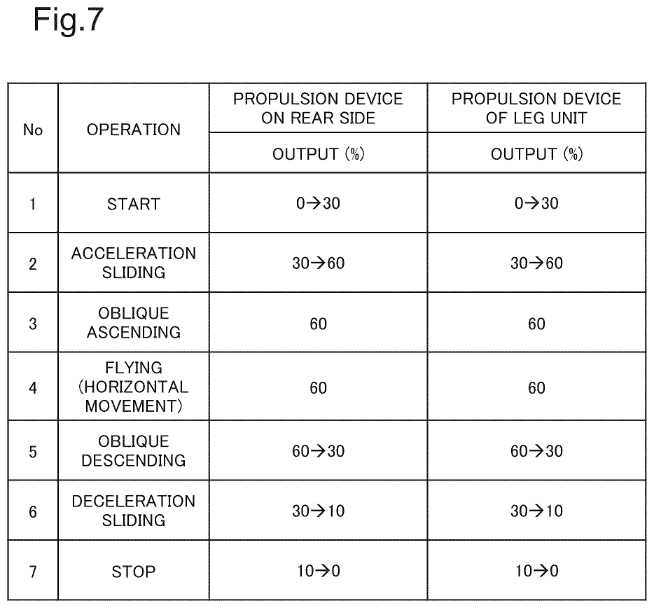

FIG. 7 is a diagram showing an example of output control of the propulsion devices 10A, 10B, 11A, and 11B in a case where the flying robot 1 is moved as shown in FIG. 6. First, the control device 20 controls the movable device 15, the hip joint actuator 6, and the shoulder joint actuators 4A and 4B to transform the posture of the flying robot 1 from the standing posture to the flying posture. Then, the control device 20 starts the propulsion devices 10A, 10B, 11A, and 11B to start the movement of the flying robot 1 in the flying posture, and increases the outputs of the propulsion devices 10A, 10B, 11A, and 11B to cause the flying robot 1 to perform acceleration sliding and then to ascend obliquely as shown in FIG. 6. In the case of oblique ascending, the control device 20 controls the inclination of the arm units 5A and 5B by the control of the shoulder joint actuators 4A and 4B. At this time, the arm units 5A and 5B are inclined in a direction of increasing the lift caused by the air resistance. When the flying robot 1 reaches the target height, the control device 20 further controls the inclination of the arm units 5A and 5B by the control of the shoulder joint actuators 4A and 4B, thereby causing the flying robot 1 to shift to the flying by the horizontal movement.

Thereafter, when the flying robot 1 approaches the destination and reaches the descent start point, the control device 20 controls the inclination of the arm units 5A and 5B by the control of the shoulder joint actuators 4A and 4B to start the descent of the flying robot 1. In addition, the control device 20 decreases the outputs of the propulsion devices 10A, 10B, 11A, and 11B. By controlling the inclination of the arm units 5A and 5B and controlling the outputs of the propulsion devices 10A, 10B, 11A, and 11B using the control device 20, the flying robot 1 obliquely descends as shown in FIG. 6. Then, when the flying robot 1 has landed, the control device 20 further decreases the outputs of the propulsion devices 10A, 10B, 11A, and 11B, the flying robot 1 slides while decelerating in the flying posture, and stops the outputs of the propulsion devices 10A, 10B, 11A, and 11B at a target stop position to stop the flying robot 1. Thereafter, the control device 20 transforms the flying robot 1 from the flying posture to the standing posture. As a result, the flying robot 1 can walk.

Even in a case where the movement including the flying of the flying robot 1 is controlled by the control of the control device 20 as described above, the flying robot 1 flies in the flying posture, in such a way that the flying distance per unit capacity of energy related to flying can be made longer than that in a case where the flying robot 1 flies in the standing posture.

### Second Example Embodiment

Hereinafter, a second example embodiment according to the present disclosure will be described. In the description of the second example embodiment, the same reference numerals are given to the same name parts as the configuration of the flying robot in the first example embodiment, and redundant description of the common parts will be omitted.

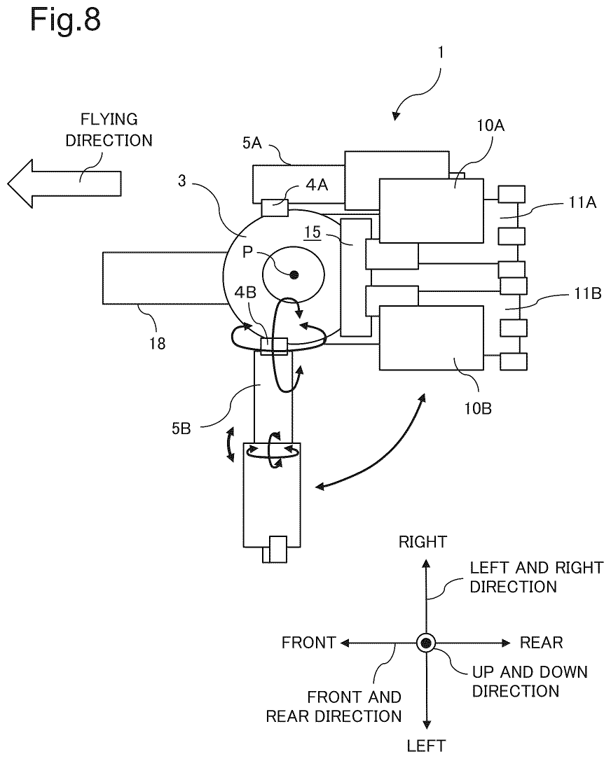

FIG. 8 is a plan view of the flying robot 1 according to the second example embodiment as viewed from above. In the second example embodiment, the shoulder joint actuators 4A and 4B are configured by three-axis actuators rotatable about three axes along the respective three directions of the front and rear direction, the left and right direction, and the up and down direction shown in FIG. 8 as rotation center axes. The arm units 5A and 5B each includes an elbow joint actuator (not shown). The elbow joint actuators are also configured by three-axis actuators. As a result, the arm units 5A and 5B are configured to be bendable at the elbow portion.

With such configurations of the arm units 5A and 5B, the arm units 5A and 5B have a high degree of freedom of movement. Therefore, when the flying robot 1 ascends or descends, it is easy to cause the arm units 5A and 5B to perform movement imitating movement of a wing of a bird or a beetle by the control of the control device 20.

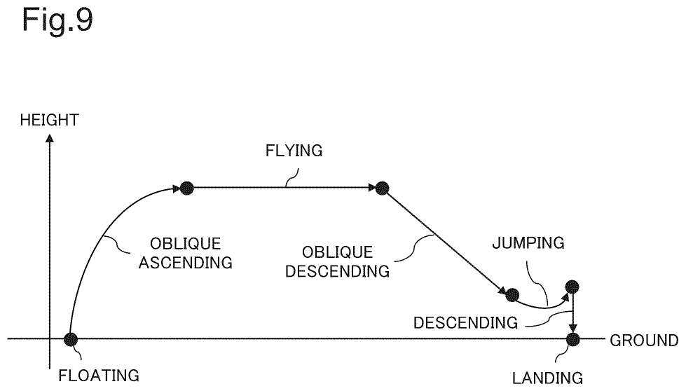

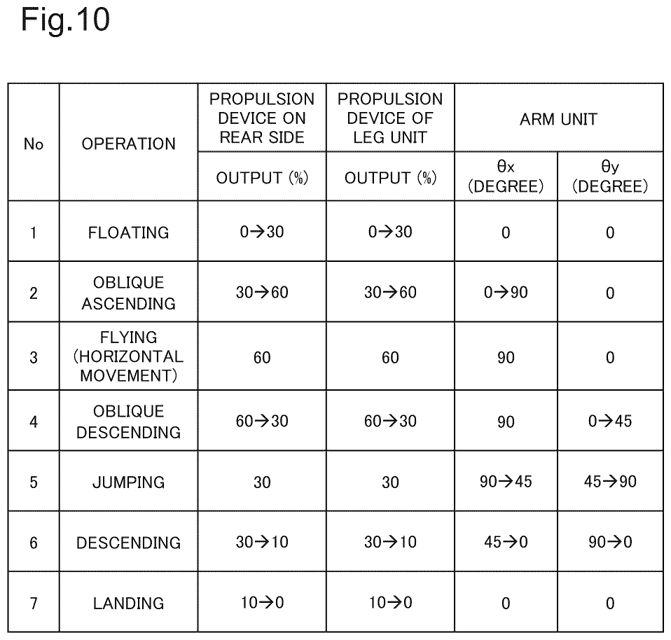

FIG. 9 is a diagram showing an example of a travel route including the flying of the flying robot 1 in the second example embodiment. FIG. 10 is a diagram illustrating an example of the outputs of the propulsion devices 10A, 10B, 11A, and 11B and the movement of the arm unit when the flying robot 1 moves as shown in FIG. 9. Furthermore, the rotation angles θx and θy shown in FIG. 10 represent the rotation angle of the arm unit 5B. The rotation angle θx is a rotation angle when the arm unit 5B is rotated about the axis in the direction along the left and right direction in FIG. 8 as the rotation center axis by the shoulder joint actuator 4B. In addition, the rotation angle θx is a positive angle in the clockwise direction when the arm unit 5B is viewed from the left side to the right side in FIG. 8 assuming that a state in which the arm unit 5B faces downward along the up and down direction is zero degrees. The rotation angle θy is a rotation angle when the arm unit 5B is rotated about the axis in the direction along the front and rear direction in FIG. 8 as the rotation center axis by the shoulder joint actuator 4B. In addition, the rotation angle θy is an angle in which the clockwise direction is positive when the arm unit 5B is viewed forward from the rear side with a state in which the arm unit 5B faces downward along the up and down direction as zero degrees.

In the example shown in FIGS. 9 and 10, the control device 20 controls the output of the propulsion devices 10A, 10B, 11A, and 11B and controls the driving of the various actuators, in such a way that the flying robot 1 floats in the standing posture and shifts to the flying posture while ascending obliquely. Then, the flying robot 1 propels in the flying posture as shown in FIG. 2 during flying (horizontal movement). When approaching the destination and reaching the descent start point, inclination control of the arm units 5A and 5B is performed by the control of the shoulder joint actuators 4A and 4B using the control device 20, and the flying robot 1 starts oblique descent.

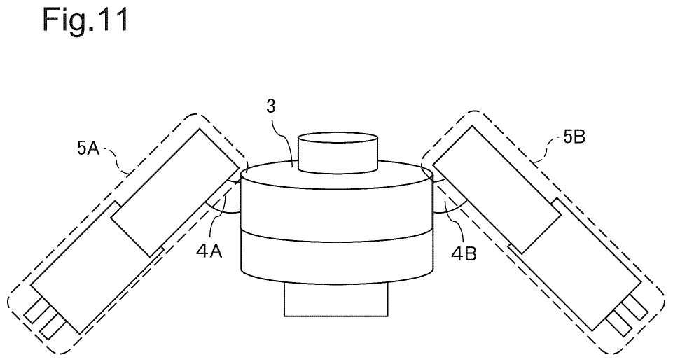

After that, the flying robot 1 once turns upward and then lands. In other words, the flying robot 1 jumps up from the oblique descent, descends in the up and down direction, and lands. At the time of shift from the jumping up to the descending, the arm units 5A and 5B are inclined to open outward in the left and right direction as shown in FIG. 11 by the control of the shoulder joint actuators 4A and 4B using the control device 20. At the time of descending in the up and down direction, the arm units 5A and 5B are controlled to face downward by the control of the shoulder joint actuators 4A and 4B using the control device 20.

The configuration of the flying robot 1 according to the second example embodiment other than the above-described configuration is similar to the configuration of the flying robot 1 according to the first example embodiment.

Also in the flying robot 1 of the second example embodiment, the posture control of the propulsion devices 10A and 10B and the direction control of the leg units 7A and 7B are performed similarly to the first example embodiment during flying, in such a way that the same effects as those of the first example embodiment can be obtained. That is, the flying robot 1 can increase the moving distance (flying distance) by flying per unit capacity of the battery (energy source) as compared with the case of flying in the standing posture (walking posture).

In addition, in the second example embodiment, the arm units 5A and 5B have a configuration for enhancing the degree of freedom of movement of the arm units 5A and 5B, and the arm units 5A and 5B are easily caused to function like wings during ascent or descent by driving control of the actuator using the control device 20. As a result, the stability of ascent and descent of the flying robot 1 can be enhanced.

### Other Example Embodiments

The present disclosure is not limited to the first and second example embodiments, and various aspects can be adopted. For example, in the first and second example embodiments, the movable device 15 is configured to variably control the posture of both the propulsion devices 10A and 10B in combination. Alternatively, the movable device 15 may be configured to variably control the posture of the propulsion devices 10A and 10B individually. In this case, the control device 20 can individually control the posture of the propulsion devices 10A and 10B, and for example, can easily control the posture of the flying robot 1 during flying more finely than in the first and second example embodiments.

In addition, the shape of the body unit 3 is not limited to the shape shown in FIG. 1 and the like. Furthermore, for example, the air resistance reducing member 18 is omitted depending on the shape of the body unit 3. Furthermore, in addition to the configurations of the first and second example embodiments, a member that functions as a tail wing during flying may be attached to the flying robot 1.

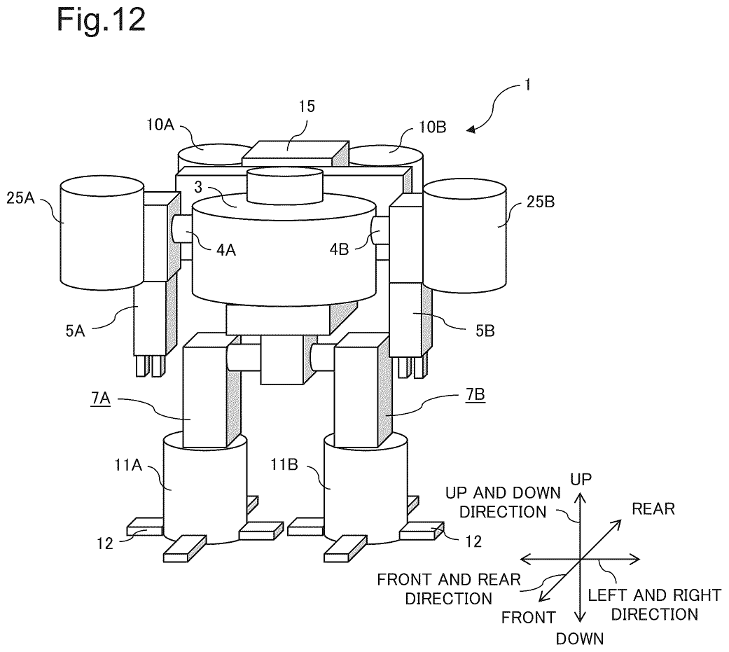

Further, in the first and second example embodiments, the flying robot 1 includes the propulsion devices 10A and 10B connected to the body unit 3 by the movable devices 15, and the propulsion devices 11A and 11B incorporated in the leg units 7A and 7B. The flying robot 1 may further include other propulsion devices. For example, FIG. 12 shows an example in which propulsion devices 25A and 25B are attached to the arm units 5A and 5B, respectively. In the example of FIG. 12, the propulsion devices 25A and 25B include rotary wings similarly to the propulsion devices 10A, 10B, 11A, and 11B, and are attached to the arm units 5A and 5B such that the rotation center axes of the rotary wings are along the extending directions of the arm units 5A and 5B. The driving control of the propulsion devices 25A and 25B is also performed by the control device 20. Regarding the driving control of the propulsion devices 25A and 25B, control associated with the control of the other propulsion devices 10A, 10B, 11A, and 11B, the arm units 5A and 5B, and the leg units 7A and 7B is performed.

Further, in the flying robot 1, a propulsion device may be attached to the bottom of the body unit 3. That is, the propulsion device may be attached to the bottom of the body unit 3 so as to be disposed in an area between the leg units 7A and 7B. As described above, the propulsion devices other than the propulsion devices 10A, 10B, 11A, and 11B may be provided at appropriate locations that do not hinder the flying of the flying robot 1 and the movement of the arm units 5A and 5B and the leg units 7A and 7B. Furthermore, the number of propulsion devices attached to the rear side of the body unit 3 via the movable device 15 is not limited to two, and for example, may be one depending on the capability of the propulsion device.

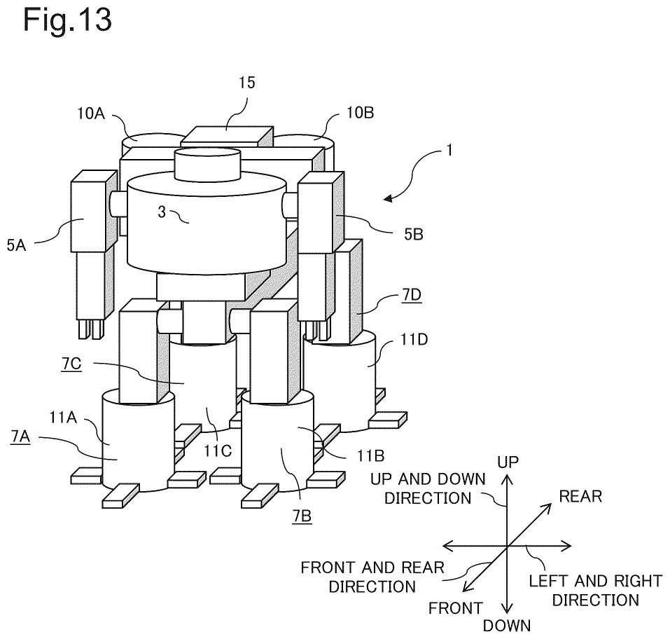

Furthermore, in the first and second example embodiments, the flying robot 1 includes two leg units 7A and 7B. Alternatively, the flying robot 1 may include three or more leg units. In the example shown in FIG. 13, the flying robot 1 includes four leg units 7A and 7B, 7C, and 7D. Further, in the example of FIG. 13, the propulsion devices 11A, 11B, 11C, and 11D are incorporated in the respective four leg units 7A and 7B, 7C, and 7D (in other words, a propulsion device is incorporated in each of all the leg units). The driving control of the propulsion devices 11A, 11B, 11C, and 11D is also performed by the control device 20. Furthermore, even when the number of leg units is three or more, the control device 20 controls the directions of the leg units to be the flying posture during flying.

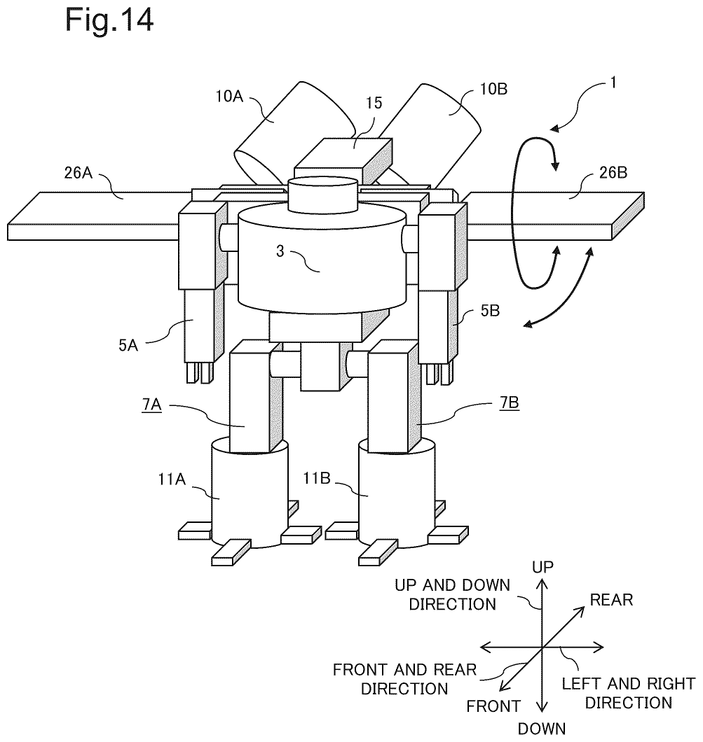

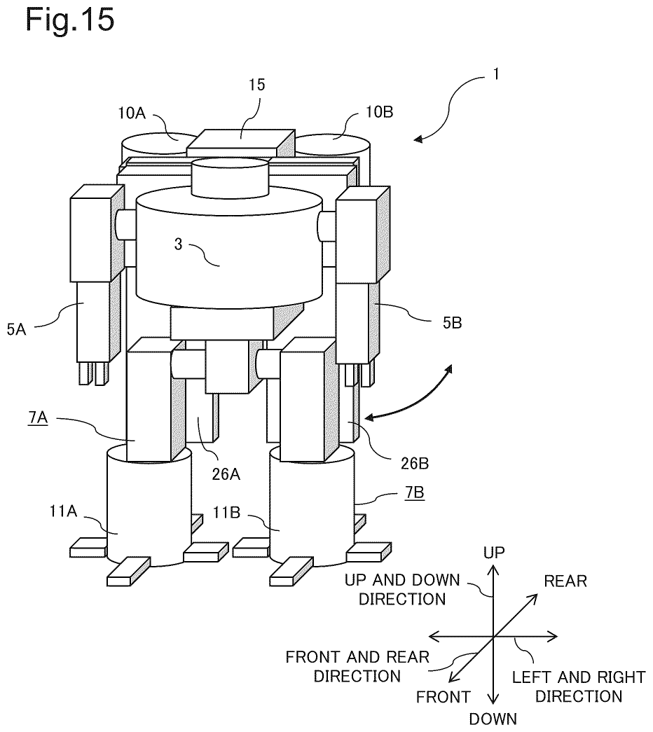

Furthermore, in the second example embodiment, an example has been described in which the flying robot 1 causes the arm units 5A and 5B to function like wings by the control of the mechanisms of the arm units 5A and 5B using the control device 20. Alternatively, for example, the flying robot 1 may include blades 26A and 26B as shown in FIG. 14. These blades 26A and 26B are connected to the rear side of the body unit 3 via an actuator (not shown). The actuator can rotate the blades 26A and 26B with an axis along the left and right direction and an axis along the front and rear direction shown in FIG. 14 as rotation center axes, respectively. As a result, the blades 26A and 26B can control the inclination of the blade surfaces of the blades 26A and 26B about the rotation center axis along the left and right direction from the state shown in FIG. 14 by the control of the actuator using the control device 20. In addition, the blades 26A and 26B can be displaced to an accommodated state as shown in FIG. 14 by being rotated about the rotation center axis along the front and rear direction by the control of the actuator using the control device 20 from the expanded state as shown in FIG. 15.

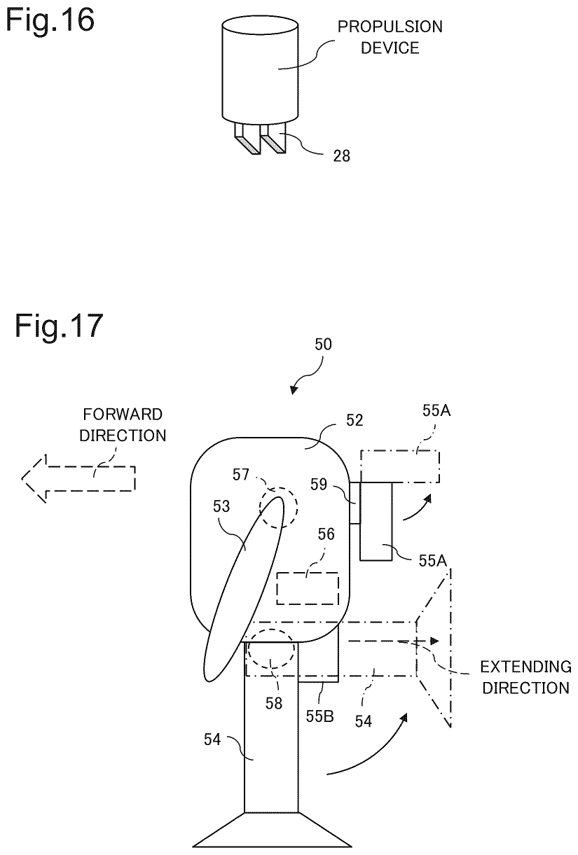

Furthermore, the propulsion device may be equipped with a thruster 28 as shown in FIG. 16, and a variable device (not shown) for changing the direction of the thruster 28. When the thruster 28 is provided, the control device 20 controls the direction of the thruster 28 by controlling the variable device, thereby controlling the flying direction of the flying robot 1 during flying.

Further, in the first and second example embodiments, the propulsion devices 10A, 10B, 11A, and 11B are devices that use battery electricity as energy. Alternatively, for example, the propulsion devices 10A, 10B, 11A, and 11B may be propulsion devices using gasoline as energy. Further, the propulsion devices 10A, 10B, 11A, and 11B may be hybrid propulsion devices using electricity and gasoline, or may be propulsion devices using energy generated by a small nuclear fusion reactor or a small nuclear reactor as an energy source. The type of energy used by the propulsion device is not limited, and the propulsion device has a structure corresponding to the type of energy. Furthermore, the flying robot 1 may have a configuration that allows wired power supply.

Furthermore, when the flying robot 1 is used for collecting an object, the flying robot 1 may include a storage container for storing the collected object in addition to the configurations of the first and second example embodiments. The size, shape, and installation location of the storage container are appropriately set in consideration of the movable range of the arm units 5A and 5B, the installation location of the propulsion device, and the like.

Furthermore, in the first example embodiment, as an example of the posture when the flying robot 1 floats, the standing posture as shown in FIG. 1 is exemplified. Alternatively, for example, the flying robot 1 may be transformed so as to tilt the body unit 3 while the leg units 7A and 7B stand upright, in such a way that the propulsion devices 10A, 10B, 11A, and 11B are aligned and the flying robot 1 may be floated from this posture. Furthermore, in each of the above-described example embodiments, the example embodiment according to the present disclosure has been described by taking a robot (flying robot) having a flying function as an example, but the present disclosure can also be applied to a robot that propels and moves underwater. In this case, the robot to which the present disclosure is applied has a structure in consideration of a waterproof measure, and a propulsion device of a type capable of coping with underwater use is adopted as the propulsion device.

FIG. 17 is a side view schematically showing a robot according to another example embodiment of the present disclosure. A robot 50 includes a body unit 52, an arm unit 53 is connected to the body unit 52 via a shoulder joint actuator 57, and a leg unit 54 is connected to the body unit 52 via a hip joint actuator 58, in such a way that the robot can walk. The robot 50 further includes a plurality of propulsion devices (in the example of FIG. 17, propulsion devices 55A and 55B). Each of the plurality of propulsion devices is a device that applies thrust to the robot 50. At least one (in the example of FIG. 17, the propulsion device 55A) of the plurality of propulsion devices is movably connected to the body unit 52 via a movable device 59. Furthermore, the robot 50 includes a control device 56. The control device 56 is a device that controls the operation of each of the shoulder joint actuator 57, the hip joint actuator 58, the plurality of propulsion devices 55A and 55B, and the movable device 59, and is, for example, a computer device.

At the time of propulsion while the propulsion device is moving using the propulsion device, the control device 56 controls the movable device 59 to perform posture control for changing the posture of the propulsion device 55A attached to the body unit 52 from the posture during walking as indicated by the solid line to the posture as indicated by the dotted line in FIG. 17. In addition, the control device 56 controls the direction of the leg unit 54 in such a way that the extending direction of the leg unit 54 during propulsion is opposite to the forward direction as indicated by the dotted line in FIG. 17 by controlling the hip joint actuator 58.

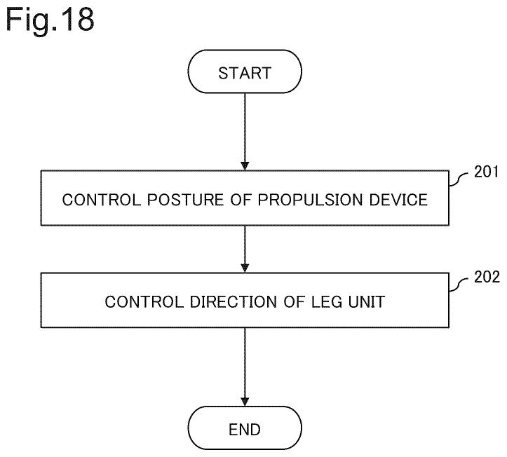

FIG. 18 is a flowchart showing an example of the control operation of the control device 56 related to the posture control of the propulsion device 55A and the direction of the leg unit 54 when the robot 50 shifts from the walking state to the state during propulsion. For example, the control device 56 controls the posture of the propulsion device 55A with respect to the body unit 52 by controlling the movable device 59, thereby variably controlling the posture of the propulsion device 55A from walking to a predetermined state (step 201). In addition, the control device 56 displaces the leg unit 54 such that the direction of the leg unit 54 becomes the direction indicated by the dotted line in FIG. 17 by controlling the hip joint actuator 58. That is, the control device 56 controls the direction of the leg unit 54 by controlling the hip joint actuator 58 such that the extending direction of the leg unit 54 is opposite to the forward direction (step 202).

The robot 50 has the above-described configuration. In this configuration, the direction of the thrust given from the propulsion device 55A to the robot 50 can be controlled by the posture control of the propulsion device 55A, and the propulsion of the robot 50 can be made larger than when the direction of the thrust of the propulsion device 55A is not controlled. Further, since the direction of the leg unit 54 is controlled such that the extending direction of the leg unit 54 is opposite to the forward direction during propulsion, the air resistance by the leg unit 54 can be reduced as compared with, for example, the case where the leg unit 54 is directed vertically downward. Due to the effect of the posture control of the propulsion device and the effect of the direction control of the leg unit 54, the robot 50 can increase the moving distance by the propulsion device per unit capacity of energy as compared with the case of moving the robot in the walking posture.

Since the robot 50 has the above-described configuration, the following effects can be obtained.

That is, as an application of the walking robot capable of moving in flying using the propeller, an application of moving to a location where it is difficult for a person to reach by flying to perform work is conceivable. However, there is a problem that it is difficult to widen the available location of the walking robot in such an application due to the following reason. That is, in consideration of mobility of the walking robot and the like, there are restrictions on the size and weight (in other words, the storage capacity) of the battery, which is a power source (energy source) of the propulsion device that can be mounted on the walking robot. Due to the restriction of the storage capacity of the battery, the distance that the walking robot can move by flying is limited, and thus, it is difficult to expand the available location where the walking robot moves by flying and performs work. On the other hand, since the robot 50 can increase the moving distance by the propulsion device per unit capacity of energy as described above, the utilization range is expected to be expanded.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A walking robot equipped with an arm unit connected to a body unit via a shoulder joint actuator and a leg unit connected to the body unit via a hip joint actuator, comprising:
a plurality of propulsion devices that are attached to the robot and apply thrust to the robot;
a movable device that movably attaches at least one propulsion device of the plurality of propulsion devices to the body unit; and
a control device that controls respective operations of the shoulder joint actuator, the hip joint actuator, the plurality of propulsion devices, and the movable device,
wherein the control device performs posture control of changing a posture of the propulsion device attached to the body unit from a posture during walking by controlling the movable device during propulsion that is moving using the propulsion device and performs direction control of the leg unit such that an extending direction of the leg unit during propulsion is opposite to a forward direction by controlling the hip joint actuator.

2. The robot according to claim 1,
wherein the plurality of propulsion devices includes a propulsion device attached to the body unit via the movable device and a propulsion device incorporated into the leg unit.

3. The robot according to claim 1,
wherein the control device controls the shoulder joint actuator to cause the arm unit to perform movement imitating movement of a wing.

4. The robot according to claim 1,
wherein a blade is further connected to the body unit.

5. The robot according to claim 1,
wherein the propulsion device is provided with a thruster for controlling a direction in a forward direction.

6. The robot according to claim 1,
wherein three or more of the leg units are provided, and the propulsion device is incorporated in each of the leg units.

7. A robot propulsion method for a walking robot equipped with an arm unit connected to a body unit via a shoulder joint actuator and a leg unit connected to the body unit via a hip joint actuator, including a plurality of propulsion devices that are attached to the robot and apply thrust to the robot, a movable device that movably attaches at least one propulsion device of the plurality of propulsion devices to the body unit; and a control device that controls respective operations of the shoulder joint actuator, the hip joint actuator, the plurality of propulsion devices, and the movable device,
wherein the control device performs posture control of changing a posture of the propulsion device attached to the body unit from a posture during walking by controlling the movable device during propulsion that is moving using the propulsion device and
performs direction control of the leg unit such that an extending direction of the leg unit during propulsion is opposite to a forward direction by controlling the hip joint actuator.
